(19) United States
(12) Patent Application Publication
(10) Pub. No.: US 2016/0260147 A1
(43) Pub. Date: Sep. 8, 2016

(54) Determining the Credibility of an On-Line User's Review

(71) Applicants: Todd King, Burbank, CA (US); Tony Tateossian, Glendale, CA (US); Steve Tateossian, Los Angeles, CA (US)

(72) Inventors: Todd King, Burbank, CA (US); Tony Tateossian, Glendale, CA (US); Steve Tateossian, Los Angeles, CA (US)

(21) Appl. No.: 14/638,991

(22) Filed: Mar. 4, 2015

(51) Int. Cl. G06Q 30/06; G10L 25/63; H04L 29/06; G10L 15/26

(52) U.S. Cl. CPC G06Q 30/0609; G10L 15/26; G10L 25/63; H04L 63/123

(57) ABSTRACT

Novel systems and methods are disclosed for obtaining information pertinent to an on-line user's review, evaluating the information to determine the trustworthiness of the review, and generating an output indicating the trustworthiness of the review. The review may be in written form, spoken form, or multimedia form including overlapping visual and spoken forms. The output may be in the form of a multi-dimensional space that is compared to shape models for trust and truthfulness.

### CROSS-REFERENCE TO RELATED APPLICATIONS

The present application claims benefit of and priority to U.S. Provisional Patent Application Ser. No. 61/949,230 filed on Mar. 6, 2014 entitled “Determining the Credibility of an On-Line User's Review,” the entire contents of which are hereby incorporated by reference herein.

### BACKGROUND

The present disclosure relates to reviews and more particularly to determining the credibility of an on-line user's review, regardless of the form of the review.

Go back over one hundred years ago and one might find a person atop a soapbox offering his or her opinion on some topic, typically a political one. Today the Internet is used as a modern day soapbox of sorts, with opinions on all topics being offered and more. Indeed, the Internet provides a platform for the everyday consumer to share a comment or rate a product purchased, a service provided, a venue visited, an event attended, and the like. Reviews of this nature have become an important source of information in the marketplace. For example, a positive review may lead to the purchase a product or service, whereas a negative review may quash the deal.

Entire companies and business models have emerged that rely on the economic value of reviews. For example, review sites exist where a consumer may post a review or view prior reviews that have been aggregated. Such reviews sites conventionally make little or no effort to restrict postings, let alone determine the veracity of the information in a review. Moreover, traditional review sites are generally supported by advertising and thus may be reluctant to post negative reviews. Review sites may even look to be compensated to keep previously posted, positive reviews. Moreover, as reviews are typically submitted anonymously, positive reviews have been known to be submitted by the businesses or individuals being reviewed. This practice has spawned a cottage industry wherein third parties are paid to generate and submit false positive reviews on behalf of the business or individual.

Even if a conventional review site desired to have only credible reviews on its site, the site may not have sufficient corollary information to determine trustworthiness, let alone systems and methods to evaluate the information.

Accordingly, systems and methods that obtain information pertinent to a review and then evaluate that information to determine the credibility of the review, written or otherwise, are desired.

### SUMMARY

An exemplary embodiment of the disclosed subject matter is a method for evaluating the trustworthiness of an on-line review comprising acquiring an identifier for an item that is the subject of a review and obtaining information pertinent to the identifier from a plurality of sources. The method preferably further comprises evaluating the obtained information to determine the trustworthiness of the review and generating an output indicating the trustworthiness of the review. The review may be in written form, spoken form, or multimedia form including overlapping visual and spoken forms. When in a non-written form, the method may further comprise transcribing spoken words that are analyzed for false statement indicators. The evaluating step may further include analyzing the cadence of speech, vocal expression, or occurrence of speech disfluency. The evaluating step may also include analyzing any eye movement, facial expressions, or body language of the reviewer.

The evaluating step may further include obtaining the Internet Protocol (“IP”) address of a reviewer who has purchased an item to determine the approximate location of the reviewer, and further obtaining the approximate location of delivery of the purchased item to compare the reviewer's location to the delivery's location. In another aspect of the disclosed subject matter, the generating step may involve generating an output in the form of a multi-dimensional space that is compared to shape models for trust and truthfulness. In yet another aspect of the disclosed subject matter, the evaluating step may include weighting information obtained during the obtaining step.

Another exemplary embodiment of the disclosed subject matter is a system for evaluating the trustworthiness of an on-line review comprising a user interface for receiving an identifier for an item that is the subject of a review, a communication interface for communicating with a plurality of information sources, and a processor. The processor preferably submits a query to at least one of the plurality of sources via the communication interface, wherein the query includes a request for information pertinent to the identifier, receives requested information about the identifier, evaluates the requested information, and generates an output indicating the trustworthiness of the review.

In yet another exemplary embodiment of the disclosed subject matter is a method for determining the quality of an on-line user review comprising determining the form of an on-line review of an item, analyzing the review according to the form of the review, and generating an output on a fixed scale indicating the quality of the review. The review is preferably subjected to a lexicographic analysis if in written form, a voice analysis if in spoken form, and a facial expression analysis and voice analysis if in multimedia form.

### BRIEF DESCRIPTION OF THE DRAWINGS

Some non-limiting exemplary embodiments of the disclosed subject matter are illustrated in the following drawings. Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described. Dimensions of components and features shown in the figures are chosen for convenience or clarity of presentation. For convenience or clarity, some elements or structures are not shown or shown only partially and/or with different perspective or from different point of views.

FIG. 1 illustrates an example environment in which one or more of the disclosed embodiments may operate;

FIG. 2 is a flow chart illustrating a high-level overview of one or more aspects of the disclosed embodiments;

FIG. 3 is a representative illustration pertinent to acquiring an identifier for an item that is the subject of a review;

FIG. 4 is a representative illustration pertinent to obtaining information relevant to the identifier from a plurality of sources;

FIG. 5 is a representative illustration pertinent to evaluating information relevant to a review to determine the trustworthiness of the review;

FIG. 5A is a representative illustration pertinent to generating an output indicative of the trustworthiness of a review that has been evaluated;

FIG. 6 is a flow chart illustrating one or more aspects of the disclosed embodiments pertinent to lexicon; and

FIG. 7 is a flow chart illustrating one or more aspects of the disclosed embodiments pertinent to IP/ship proximity.

### DETAILED DESCRIPTION

A general problem in the field of on-line user reviews is the lack of credibility or trustworthiness of the review itself. A general solution is a means for determining the trustworthiness of an on-line review.

A technical problem in the field of on-line reviews is a lack of sufficient information pertinent to a review to be able to determine if a review is credible, as well as methods of evaluating that information. A technical solution implementing the spirit of the disclosed inventions is obtaining sufficient corollary information to be able to input into a determination of credibility, and inputting this information into a multi-faceted, weighted assessment to determine credibility of a review, whether or not that review has been made via text.

Potential benefits of the general and technical solutions provided by the disclosed subject matter include trustworthy reviews that consumers may readily rely upon when making a purchasing decision. Additional benefits also include increased consumer confidence levels about an intended purchase, as well as increased consumer confidence of a site that employs one or more aspects of the disclosed subject matter. Such increased confidence yields another benefit, namely, higher traffic to the site that may then lead to increased sales, brand recognition, and customer satisfaction in the long run.

A general non-limiting overview of practicing the present disclosure is presented below. The overview outlines exemplary practice of embodiments of the present disclosure, providing a constructive basis for variant and/or alternative and/or divergent embodiments, some of which are subsequently described.

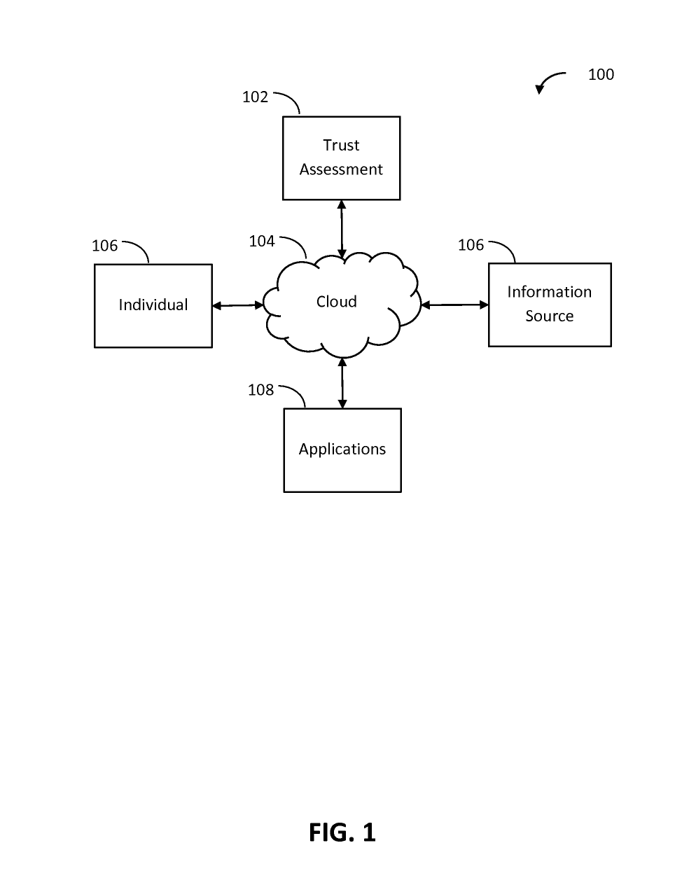

FIG. 1 illustrates an example environment in which a system or method embodying one or more aspects of the disclosed invention may operate. As seen in FIG. 1, cloud 104 represents various systems and hosts in which one or more interconnected networks may communicate with each other. Individual 106 represents a person, autonomous application, or client service acting on behalf of a person. Individual 106 may communicate using any method available in the cloud 104 including but not limited to web browsers, mobile applications, hosted applications, kiosks, or specialized devices. In a particular embodiment, cloud 104 may be common to all participating elements. In other embodiments, cloud 104 may be different for each type of communication. Cloud 104 may provide communication over private networks, wireless networks, satellite networks, cellular networks, paging networks, wide area networks, or other network-addressable systems.

In the environment illustrated by FIG. 1, individual 106 communicates through cloud 104 with one or more applications 108. The application 108 may communicate through the same cloud 104 or through a different cloud with a trust assessment service 102 embodying one or more aspects of the disclosed invention. The trust assessment service 102 will assess the available information and provide an evaluation of trust. To determine the level of trust, the trust assessment service 102 may retrieve additional information from one or more information sources 106. Access to the additional information may be through a common cloud 104 or through alternate clouds. The amount and type of information available may vary from assessment to assessment so the trust assessment service 102 adapts to the amount of information available and provides a qualified determination of trust, as disclosed in more detail below.

Exemplary embodiments as described herein may be implemented utilizing a computing device and a network having access to a plurality of nodes one or more of which can host a server with data. A computing device may include a user interface to facilitate interaction with a user. A computing device may be a personal computer, a portable computer, a smartphone, or the like. Servers or data storage devices at a network location may include reviews for items that are of interest to the user, as well as other relevant information. The storage devices may be located in the server and accessible to the user device over a network in a conventional manner.

As such, one aspect of the disclosed subject matter includes a system for evaluating the credibility of a review comprising a user interface, a communication interface for communicating with a plurality of information sources, and a processor for submitting a query to one or more of the information sources via the communication interface. The query may include a request to receive information about an item that is the subject of the review. The same or related processor may be then be configured to assess the review and all pertinent information related thereto, and then generate a trustworthiness score based on the assessment. As understood by those skilled in the art, part or all of the disclosed subject matter may be executed in any combination of mobile platforms and computing devices.

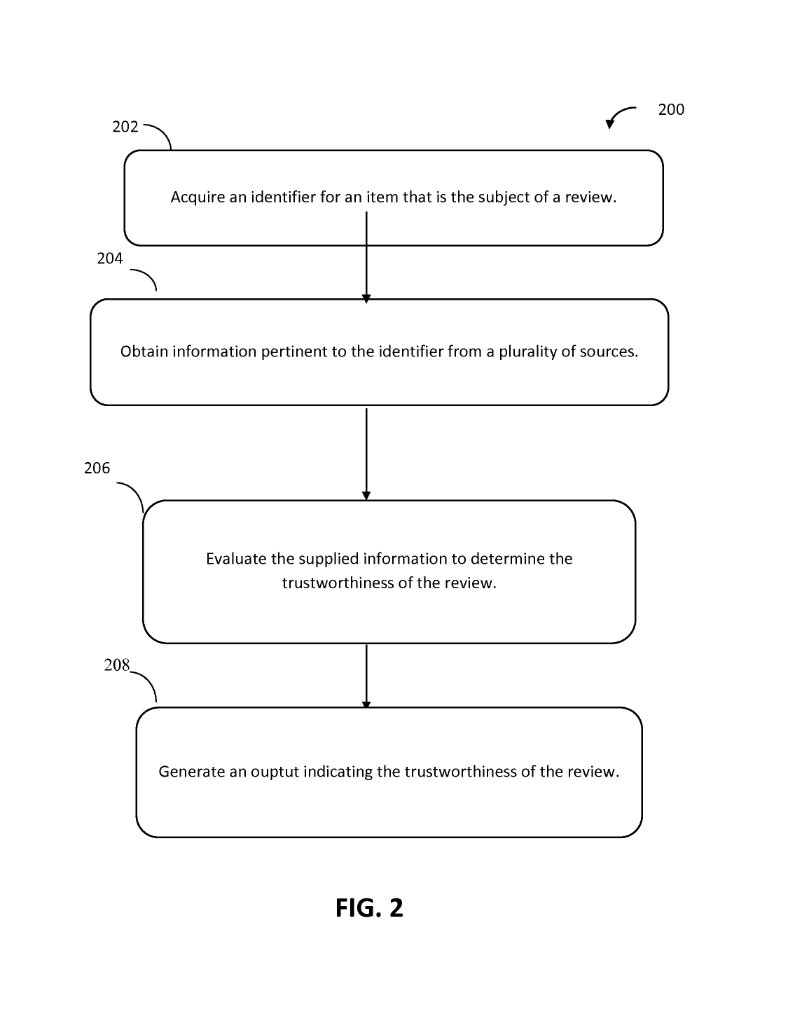

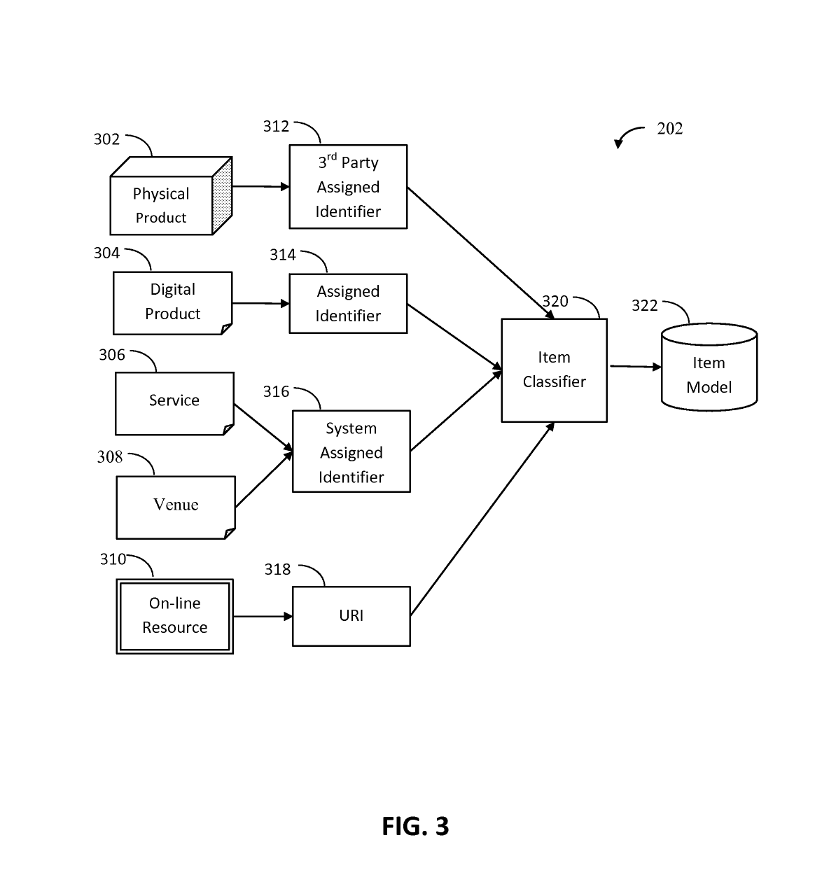

FIG. 2 is a flow chart illustrating a high-level overview of one or more aspects of the disclosed embodiments. As seen in FIG. 2, block 202 entails acquiring an identifier for an item that is the subject of a review. The identifier is preferably a unique identifier that may be acquired by an individual by scanning a bar code, a quick response code, an image, or like encoding. Scanning may be done via a smartphone or the like by taking a picture or video of the product and/or code itself, the latter of which may be printed for display in a store or on a business card, for example. The picture or video may then be uploaded wherein prior reviews and other pertinent information, such as the store's review page, may be provided back to the individual's screen. In a similar manner, a consumer may use one or more aspects of the disclosed embodiments to upload a picture and review or a video review. The identifier may also be acquired through a search, a location service, other like techniques, as disclosed in more detail below regarding FIG. 3.

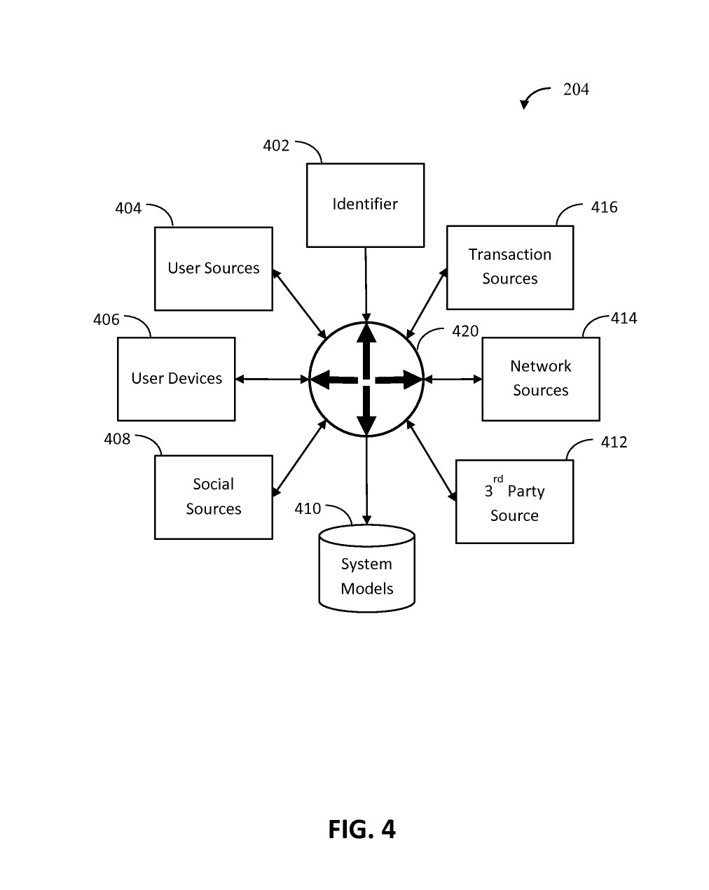

Once the identifier has been acquired, the next step preferably involves obtaining information pertinent to the identifier from one or more sources, as seen in block 204 of FIG. 2 and disclosed in more detail below in the context of FIG. 4. The collection of information is then evaluated in block 206 to determine the trustworthiness of review information provided. In some embodiments, this collected information is stored in memory and persists at least until the assessment completes. In other embodiments, the information is placed in a storage media that may be local or in the cloud. Once evaluated, an output is generated indicating the trustworthiness of the review, as illustrated in block 208.

FIG. 3 is a representative illustration pertinent to acquiring an identifier for an item that is the subject of a review, as exemplified in block 202 of FIG. 2. In the context of the disclosed subject matter, each review is about an item. As used herein, an item refers to a physical product 302, a digital product 304, a service 306, a venue 308, or an on-line resource 310. However, an item as understood herein need not be so limited but may include other related concepts. As seen in FIG. 3, a physical product 301 may have an identifier assigned by a third party 312. A digital product 304 may be assigned an identifier, as per block 314. A service 306 or venue 308 may have an identifier assigned by a sub-system 316. An on-line resource 310 may be identified by its uniform resource identifier or URI, as per block 318. Each of these identifiers 312-318 may be classified and/or categorized by an item classifier 320 for further use as an item model 322 or the like by one or more other aspects of the disclosed invention.

FIG. 4 is a representative illustration pertinent to obtaining information relevant to the identifier from a plurality of sources, as exemplified in block 204 of FIG. 2. As seen in FIG. 4, upon receiving an identifier 402, the multi-information collection sub-system 420 disclosed herein may obtain information about user sources 404, the device being used 406, social sources 408, system models 410, third party sources 412, network sources 414, transaction sources 416, and the like.

User device 406 information may include the geographic location of the device being used to generate the review, user identification, and type of device. In the context of social services 408, a social source may include information pertinent to a given name, location, preferences, or associations. Example social sources include Facebook, Twitter, and LinkedIn. A third party source 412 may provide independent confirmation of information from other sources. For example, identity information of a reviewer may be confirmed through a bureau or a business member list. Network sources 414 may include information about the IP address of the reviewer's device. Transaction sources 416 may include information about the item comprising the purchase of goods or services, attendance at an event, and the like. The collection sub-system 420 may also obtain corollary information from the reviewer upon request to the reviewer.

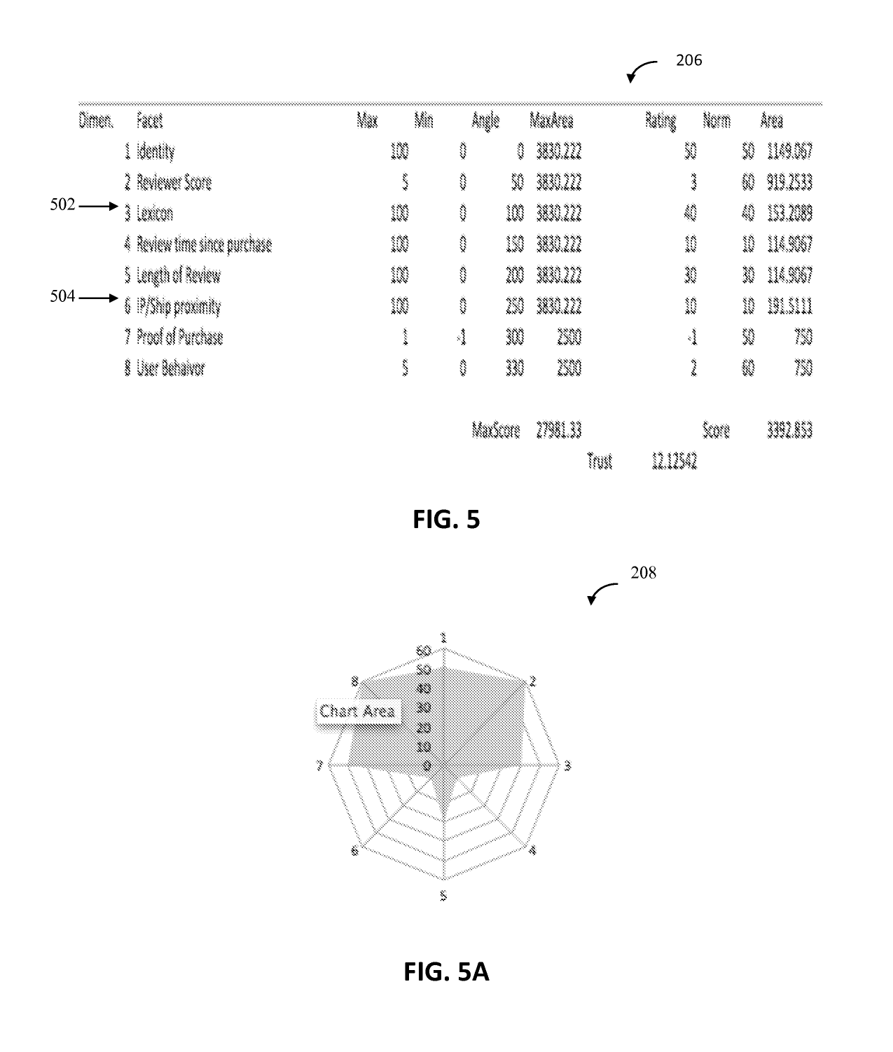

FIG. 5 is a representative illustration pertinent to evaluating information relevant to a review to determine the trustworthiness of the review, as exemplified in block 206 of FIG. 2. As seen in FIG. 5, determining the trustworthiness of a review may include an evaluation of several facets or factors. The factors may include but are not limited to the identity of the reviewer, i.e., whether the individual writing the review is who he or she claims to be, the reviewer's score, the lexicon employed by the reviewer (see call-out 502), review time since purchase, length of review, IP/ship proximity (see call-out 502), proof of purchase, and user behavior. Each factor may be treated equally in the evaluation or, in the alternative, treated differently by given more weight to one compared to another. For example, the identity of the user may be given a higher weight compared to proof of purchase, as illustrated in FIG. 5.

Each factor of a review, whether text or other form, may be combined with other factors, including those from other sources and using other methods, to form a multi-dimensional space. This multi-dimensional space may be compared to shape models for trust and truthfulness. How well the multi-dimensional space matches the shape model may be expressed as a number on a fixed scale, providing a concise measure of trust and truthfulness. This number may be displayed in many forms including a number, star rating, a gradient bar, or other useful visual form. One such visual representation or output indicating the trustworthiness of the review, per block 208, is illustrated in FIG. 5A.

In the context of using a score or the like as a visual representation, a higher score preferably indicates a higher trust in the review. A lower score indicates a lower trust in the review. A reviewer who has received a sufficient number of sufficiently high scores may even be given a badge or other indicia to provide an impression of overall trustworthiness.

To elaborate further with regard to how factors may be used and weighted in a trustworthiness evaluation process, a higher score may be generated as an output when a reviewer identified by their IP address, for example, reviews similar products and/or services. Conversely, if the same reviewer reviews unrelated items, then the score may be lower. Similarly, if a reviewer's social profile is obtained via one or more social sources 408, such information may be used to designate a reviewer as being knowledgeable about a particular product or service. By way of further example, if a reviewer responds to comments to the review, then the score may be higher due to such user behavior. The rate at which reviews are submitted may also be used to determine the score. If the reviews are submitted in quick succession, the score may be lower. If the reviews are submitted in a gradual manner, the score may be higher.

Businesses selling products or services may also provide credentials (in the form of a pin number or a bar code, for example) to purchasers of their products or services. The purchasers may then use these credentials to validate their reviews of the purchased products or services. The reviewer may input their credentials before providing a review. The score for reviewers with valid credentials may be higher than those without such credentials.

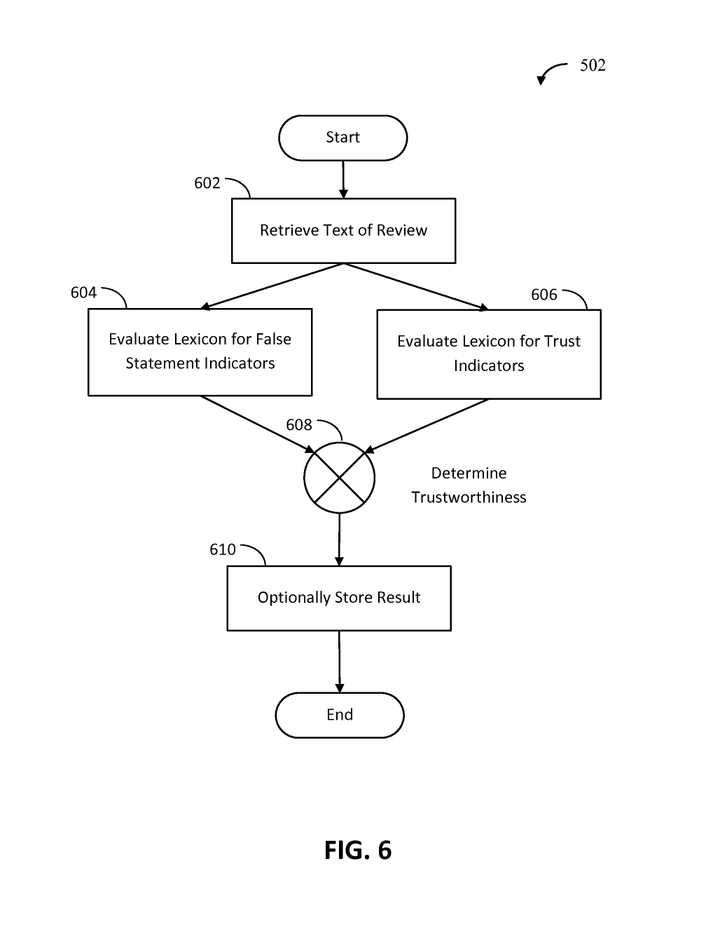

FIG. 6 is a flow chart illustrating one or more aspects of the disclosed embodiments pertinent to lexicon 502, as exemplified in FIG. 5, to determine the truthfulness of statements made in a review. Such analysis is used to determine if word usage, phrasing, and/or expressions are typical or indicative of truthful statements. The likeliness of truthfulness may also be rated on a scale, such as that illustrated in FIGS. 5 and 5A. A method for performing lexicographic analysis is described in, for example, U.S. Patent Publication No. 20070010993, the subject matter of which is incorporated herein by reference.

Turning in detail to FIG. 6, a method in accordance with an exemplary lexicographic analysis may commence at step 602 wherein the text of a review is retrieved. Where the review is already in written form, the text of the review is extracted and inputted into the trust assessment block 102 to be evaluated. Where the review is in spoken form, a transcript of verbal statements is preferably generated and then inputted into the trust assessment block 102. Once inputted, the text is evaluated for false statement indicators, per block 604, and also evaluated for trust indicators, per block 606. These evaluations are preferably combined at block 608 to determine a trustworthiness score, which may optionally be stored as per block 610. Moreover, for spoken reviews, characteristics of the speech patterns may also be assessed including the cadence of the speech, vocal expression, and occurrence of speech disfluency. Where the review is in multimedia form, further analysis may include determination of eye movement, facial expressions (including micro-expressions), body language, emotions, and scene composition that may be used to determine the truthfulness of the speaker. A method for evaluating facial expressions is described in, for example, U.S. Patent Publication No. 20130300900, the subject matter of which is incorporated herein by reference.

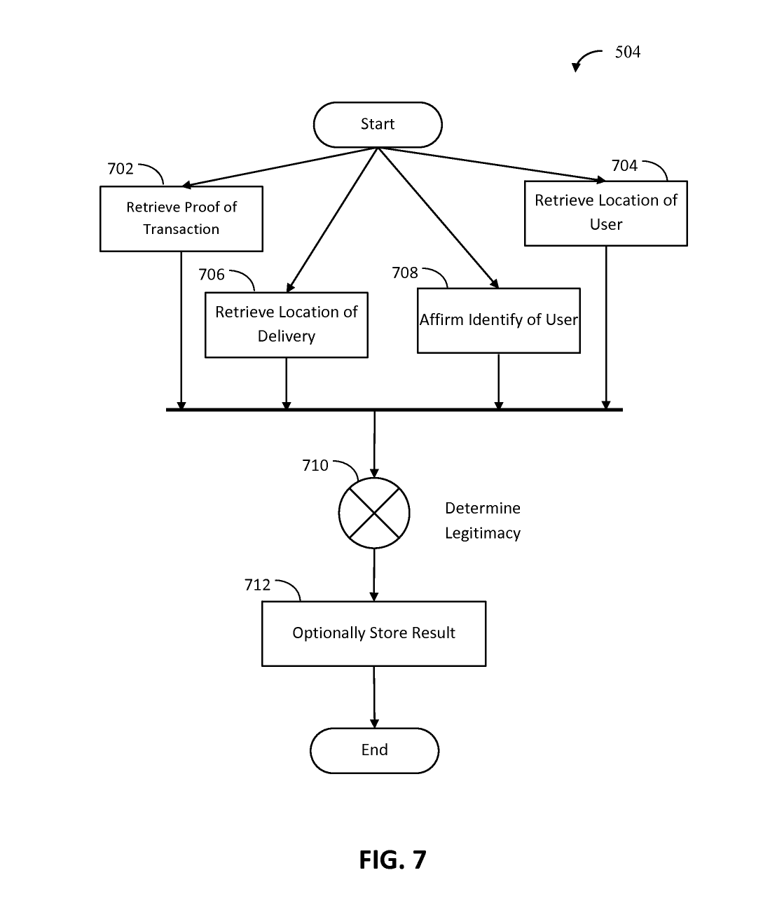

FIG. 7 is a flow chart illustrating one or more aspects of the disclosed embodiments pertinent to IP/ship proximity 504, as exemplified in FIG. 5. As seen in FIG. 7, a supplemental criterion for validating a reviewer may include matching proof of purchase and delivery of a product or service to a reviewer. Accordingly, a first step preferably involves retrieving proof of transaction, per block 702, while also retrieving the location of the user, per block 704. In addition, the location of delivery may be retrieved, per block 706. Moreover, the identity of the review is preferably affirmed, per block 708. Next, the legitimacy of the reviewer is determined, per block 710. This determination is optionally stored, per block 712.

While certain embodiments have been described, the embodiments have been presented by way of example only and are not intended to limit the scope of the inventions. Indeed, the novel devices and methods described herein may be embodied in a variety of other forms; furthermore, various omissions, substitutions, and changes in the form of the devices and methods described herein may be made without departing from the spirit of the inventions. The accompanying claims and their equivalents are intended to cover such forms or modifications as would fall within the scope and spirit of the inventions.

1. A method for evaluating the trustworthiness of an on-line review comprising:
acquiring an identifier for an item that is the subject of a review;
obtaining information pertinent to the identifier from a plurality of sources;
evaluating the obtained information to determine the trustworthiness of the review; and
generating an output indicating the trustworthiness of the review.

2. The method according to claim 1, wherein the review is a video review.

3. The method according to claim 2, further comprising transcribing spoken words used during the video, and wherein the evaluating step includes analyzing the lexicon employed for false statement indicators.

4. The method according to claim 2, wherein the evaluating step includes analyzing the cadence of speech used during the video review, vocal expression, or occurrence of speech disfluency.

5. The method according to claim 4, wherein the evaluating step further includes analyzing any eye movement, facial expressions, or body language of the reviewer.

6. The method according to claim 1, wherein the evaluating step includes obtaining the IP address of a reviewer who has purchased an item to determine the approximate location of the reviewer, and further obtaining the approximate location of delivery of the purchased item to compare the reviewer's location to the delivery's location.

7. The method according to claim 1, wherein the generating step involves generating an output in the form of a multi-dimensional space that is compared to shape models for trust and truthfulness.

8. The method according to claim 1, wherein the evaluating step includes weighting information obtained during the obtaining step.

9. A system for evaluating the trustworthiness of an on-line review comprising:
a user interface for receiving an identifier for an item that is the subject of a review, the identifier being unique to the item;
a communication interface for communicating with a plurality of information sources; and
a processor for:
submitting a query to at least one of the plurality of sources via the communication interface, the query including a request for information pertinent to the identifier;
receiving requested information about the identifier;
evaluating the requested information; and
generating an output indicating the trustworthiness of the review.

10. The system according to claim 9, wherein the review is a video review.

11. The system according to claim 10, further comprising transcribing spoken words used during the video, and wherein the processor evaluates the lexicon employed for false statement indicators.

12. The system according to claim 10, wherein the processor evaluates the cadence of speech used during the video review, vocal expression, or occurrence of speech disfluency.

13. The system according to claim 10, wherein the processor evaluates any eye movement, facial expressions, or body language of the reviewer.

14. The system according to claim 9, wherein the requested information includes the IP address of the reviewer and the location of delivery of a purchased item to compare the reviewer's location to the delivery's location.

15. The system according to claim 9, wherein the output is in the form of a multi-dimensional space that is compared to shape models for trust and truthfulness.

16. The system according to claim 9, wherein the processor evaluates the requested information after weighting the requested information.

17. A method for determining the quality of an on-line user review comprising:
determining the form of an on-line review of an item, the review being in one of a written form, a spoken form, or a multimedia form including overlapping visual and spoken forms;
analyzing the review according to the form of the review wherein:
the review is subjected to a lexicographic analysis if in written form;
the review is subjected to a voice analysis if in spoken form;
the review is subjected to facial expression analysis and voice analysis if in multimedia form; and
generating an output on a fixed scale indicating the quality of the review.

18. The method according to claim 17, wherein the item is a service.

19. The method according to claim 18, wherein the output is in the form of a multi-dimensional space that is compared to shape models for trust and truthfulness.
